(19) United States
(12) Patent Application Publication
(10) Pub. No.: US 2010/0312623 A1
(43) Pub. Date: Dec. 9, 2010

(54) SYSTEM AND METHOD FOR LOCAL MARKETING AT THE POINT OF SALE

(76) Inventors: Daniel Almodóvar Herráiz, Madrid (ES); Javier Montaner Gutierrez, Madrid (ES); Alberto Martin Briega, Madrid (ES)

Correspondence Address: STITES & HARBISON PLLC, 1199 NORTH FAIRFAX STREET, SUITE 900, ALEXANDRIA, VA, 22314, US

(21) Appl. No.: 12/764,564

(22) Filed: Apr. 21, 2010

(30) Foreign Application Priority Data
Apr. 22, 2009 (ES) P200930086

(51) Int. Cl. G06Q 30/00

(52) U.S. Cl. 705/14.4

(57) ABSTRACT

System and method for local marketing at the point of sale, the system comprising:
at least one local unit (1,1′,1″) with cellular radio transceiver means, located at a local marketing area within a coverage area (4,4′,4″), configured for:
   broadcasting a LAC different from any other LAC of the radio cells in the surroundings;
   establishing a Location Update dialogue with any mobile phone (3,3′,3″) answering to the LAC broadcast, obtaining its IMSI number;
   sending a Location Updating Reject message to each mobile phone (3,3′,3″) whose IMSI number has been obtained;
   sending said IMSI number to a central unit (2);
the central unit (2), configured to:
   obtain, for each IMSI number, a user identity useful to advertisers;
   receive requests from at least one advertiser (9,9′,9″) for capturing user identities in local marketing areas;
   determine the advertisers (9,9′,9″) interested in the user identities received, and provide (20) them to the corresponding advertiser (9,9′,9″).

### FIELD OF THE INVENTION

The present invention lies in the field of mobile communications, and more specifically in providing a set of techniques to manage a local marketing campaign next to the point of sale.

### BACKGROUND OF THE INVENTION

Local marketing at the point of sale is a topic known for many years, and it has a great business potential in aspects of the marketing mix such as advertising and sales promotion (e.g. send discount coupons to people at a shopping center, for shops that are just right there). However, so far it has not succeeded commercially as much as expected. In addition to privacy and intrusion issues, one of the reasons is the technical capability of detecting what people are there and reaching them through a communications channel.

The existing solutions, from less to more technically advanced, would be the following:
A stand with a person addressing directly people passing by and offering brochures and paper coupons.
A stand without any person and with a screen that provides commercial information. It can include a limited level of interactivity, e.g. by pressing buttons, and it could deliver coupons, e.g. printing them.
A stand without any person and with a Bluetooth short-range communication system that can interact with the mobile phones of people and deliver to them ads and virtual coupons (e.g. 2D codes). The same could be done with other short-range radio such as WiFi or RFID, but Bluetooth is the most popular due to its availability in many mobile phones.
An absolute positioning method (e.g. GPS, cellular) that compares the user position with the geographical area of the shopping center, detects the event of entering there, and then, triggers the delivery of messages through the cellular channel.

The automatic solutions, without people, are obviously cheaper. However, the existing relative positioning methods, based on Bluetooth or similar radios, have a number of known drawbacks: not all mobile phones have the Bluetooth hardware, not all have it active (especially for saving battery), the discovery time can be high and the number of concurrent connections is low (generally only seven). Regarding the absolute positioning methods, the ones based on the cellular network are not accurate enough (cell resolution) and require a continuous polling or tracking of user's position that consumes network resources; and the ones based on the terminal (GPS) do not work indoors and require an internal process (local tracking) that consumes battery.

Document US2003064713 discloses an intelligent, non-intrusive, adaptive wireless discount coupon delivery system over GPRS. It describes a system which includes an enabler based on proximity detection approach, but using the real base stations in the mobile network and requiring active calls by the mobile phones (in order to be detected at the cell). However, the present invention does not use a real base station (it is indeed a fake base station) and does not require active calls in the mobile phone, it works for any switched-on mobile phone present in the coverage area.

It is well-known that abbreviations and acronyms are frequently used in the mobile telephony field. Below is a glossary of acronyms/terms used throughout the present specification:

### 3GPP The 3rd Generation Partnership Project

### BSC Base Station Controller

### BTS Base Transceiver Station

### GPRS General Packet Radio Service

### GSM Global System for Mobile Communications

### HLR Home Location Register

### IMSI International Mobile Subscriber Identity

### IP Internet Protocol

### MCC Mobile Country Code

### MLP Mobile Location Protocol

### MMS Multimedia Messaging System

### MNC Mobile Network Code

### MSISDN Mobile Subscriber Integrated Services Digital Number

### MSC Mobile Switching Centre

### LAC Location Area Code

### PLMN Public Land Mobile Network

### RNC Radio Network Controller

### SGSN Serving GPRS Support Node

### SMS Short Message Service

### TIMSI Temporary International Mobile Subscriber Identity

### UMTS Universal Mobile Telecommunications System

### WAP Wireless Application Protocol

### SUMMARY OF THE INVENTION

The invention relates to a method and system for local marketing at the point of sale according to claim 1 and claim 8, respectively. Preferred embodiments of the method and system are defined in the dependent claims.

Compared to the drawbacks previously commented, the proposed invention provides several advantages:
it is automatic;
it supports the delivery of virtual ads and coupons to an unlimited number of users, via the cellular channel;
it works with any standard cellular phone;
it works with phones in idle mode (i.e. without active calls or data communications);
it has very low battery consumption;
it does not require continuous polling or tracking of user's absolute position, because it is based on a local unit at the point of sale (relative positioning);
provides high resolution (coverage area can be reduced to a few meters);

The invention is composed of:

1. Transmitting and receiving function performed by a local unit that uses standard cellular mechanisms (similar to the ones in existing BTS and BSC/RNC). It broadcasts system information with a certain LAC (Location Area Code), forces all mobile phones of the same network within its reach area to send a Location Update message, captures the identity (e.g. IMSI) of those phones and sends back a Location Update reject message to avoid further disturbing the phones. The radiation pattern of the antenna system can be modified to shape the coverage area convenient to the particular use case.

2. Collection function where all the IMSI identities are forwarded. It will typically be centralised.

3. Identity management function, which translates the IMSI identity into an identity with commercial value for advertisers (e.g. MSISDN or PLMN). It will typically require the participation of a mobile operator, since the IMSI is an identity managed internally in the cellular network.

4. Gateway function to advertising systems that triggers the event of a user being detected by the local unit. The gateway function will include typically an interface to advertisers, a mechanism for privacy control and brokerage between the advertisers and the local units. Once that the advertising systems are informed about such event, they will act accordingly (e.g. sending an MMS with a coupon), depending on the configuration of the campaign, segmentation, targeting settings, etc. The behaviour of the advertising systems once they have received the trigger is out of the scope of the invention, which covers only the system and method for producing that trigger and associate a valid identity (e.g. MSISDN) that allows the advertising systems the delivery through the regular cellular channel (e.g. SMS, MMS, WAP Push).

The method for local marketing at the point of sale comprises:
broadcasting, in the licensed spectrum of at least one mobile network operator and from at least one local unit, each one located at a local marketing area within a corresponding coverage area, a LAC different from any other LAC of the radio cells of the mobile network in the surroundings;
establishing each local unit a Location Update dialogue with any mobile phone answering to the LAC broadcast, obtaining from each answering mobile phone its IMSI number;
sending each local unit a Location Updating Reject message to each mobile phone whose IMSI number has been obtained;
sending each local unit the IMSI number of each answering mobile phone to a central unit;
obtaining, for each IMSI number, a user identity useful to advertisers;
offering an interface for at least one advertiser to perform requests for capturing user identities in at least one determined local marketing area;
determining, for each user identity received, the at least one advertiser interested in capturing the user identities in the local marketing area corresponding to said user identity received. That is, brokering between the requests from the advertisers and the identities obtained (because the request from a single advertiser can be associated to several local units, and, in turn, the identities obtained from a single local unit can be associated to several advertisers); and
providing said user identity to the at least one interested advertiser.

The identity useful to advertisers is preferably the MSISDN (i.e. phone number) or the PLMN (i.e. a number that indicates the country and mobile operator).

The coverage area of the at least one local unit can be configurable through at least one of the following parameters:
the transmission power to modify the reach;
the radiation pattern of the antenna system to modify the shape of the coverage area.
the system information parameters that the regular cells in the mobile network are broadcasting to all mobile phones.

The step of obtaining, for each IMSI number, the identity useful to advertisers can also comprise retrieving said identity corresponding to said IMSI number from the corresponding mobile operator.

The method can also comprise checking, before providing the user identity to the at least one interested advertiser, in internal or external databases if there is permission to provide the user identity, so that said user identity is only provided to the at least one interested advertiser with the corresponding permission.

The broadcasting of the at least one local unit can be carried out at the same time in spectrum of different radio technologies of the same mobile network operator or at the same time in spectrum of different mobile operators (in this case the central unit manages the identities captured for the mobile phones of those said mobile operators).

The system for local marketing at the point of sale comprises:
at least one local unit provided with cellular radio transceiver means for transmitting and receiving signals in the licensed spectrum of at least one mobile network operator, each local unit being located at a local marketing area within a corresponding coverage area, and being configured for:
   broadcasting a LAC different from any other LAC of the radio cells of the mobile network in the surroundings;
   establishing a Location Update dialogue with any mobile phone answering to the LAC broadcast, obtaining from each answering mobile phone its IMSI number;
   sending a Location Updating Reject message to each mobile phone whose IMSI number has been obtained;
   sending said IMSI number to a central unit;
a central unit configured to:
   obtain, for each IMSI number, a user identity useful to advertisers;
   receive requests from at least one advertiser for capturing user identities in at least one determined local marketing area;
   determine, for each user identity received, the at least one advertiser interested in capturing the user identities in the local marketing area corresponding to said user identity received, and provide said user identity to the at least one interested advertiser.

The at least one local unit preferably comprises means for configuring at least one of the following parameters that determines its corresponding coverage area:
the transmission power to modify the reach;
the radiation pattern of the antenna system to modify the shape of the coverage area;
the system information parameters that the regular cells in the mobile network are broadcasting to all mobile phones.

In another preferred embodiment the central unit is remote to the at least one local unit and comprises data collection means configured for remotely managing the at least one local unit.

The central unit can comprise management means configured to, for each IMSI number received, retrieve the identity corresponding to said IMSI number from the corresponding mobile operator.

The central unit can be further configured to check, before providing the user identity to the at least one interested advertiser, if there is permission to provide the user identity, so that said user identity is only provided to the at least one interested advertiser with the corresponding permission.

The at least one local unit can be configured to carry out the broadcasting at the same time in spectrum of different radio technologies of the same mobile network operator or at the same time in spectrum of different mobile operators, being in the latter case the central unit configured to manage the identities captured for the mobile phones of those said mobile operators.

### BRIEF DESCRIPTION OF THE DRAWINGS

To complete the description and, in order to provide for a better understanding of the invention, a set of drawings is provided. Said drawings form an integral part of the description and illustrate preferred embodiments of the invention, which should not be interpreted as restricting the scope of the invention, but just as examples of how the invention can be embodied. The drawings comprise the following figures:

FIG. 1 shows a basic diagram of the system object of invention.

### DETAILED DESCRIPTION OF THE PREFERRED EMBODIMENTS

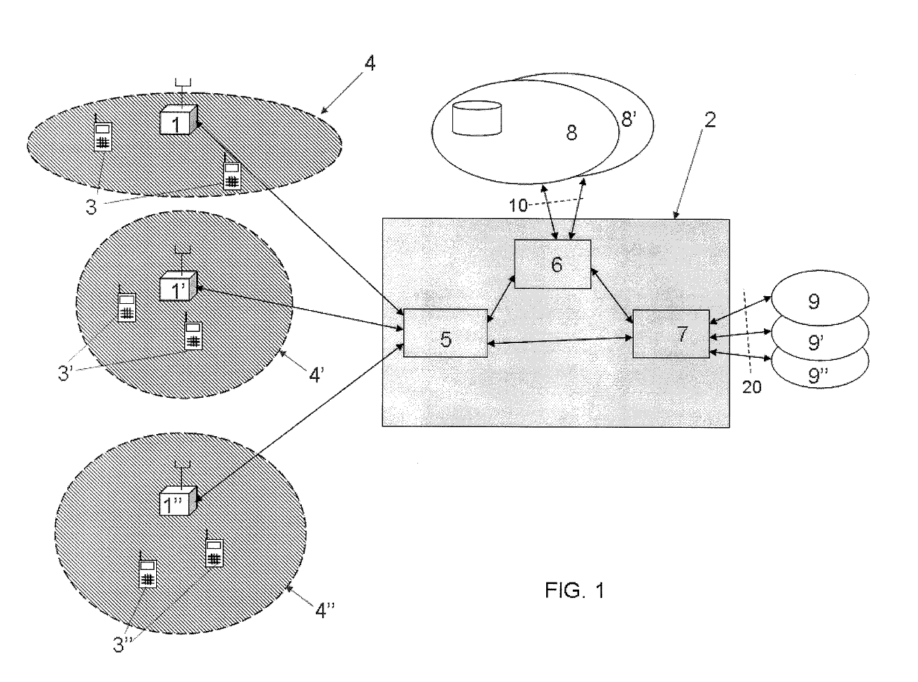

The system, represented schematically in FIG. 1, is composed of at least one local unit (1,1′,1″) and a central unit 2, local or remote to the previous one.

The local unit (1,1′,1″) has the following function:
An identity capture function that uses standard cellular mechanisms (similar to the ones in existing BTS and BSC/RNC). It broadcasts system information with a certain LAC (Location Area Code), forcing the mobile phones (3,3′,3″) of the same network within its reach area, the coverage area (4,4′,4″), to send a Location Update message. It captures then the identity (e.g. IMSI) of those phones (3,3′,3″) and sends back a Location Update reject message to avoid further disturbing the phones (during a certain period chosen by the operator or until they are switched off). The radiation pattern of the antenna system can be modified to shape the coverage area (4,4′,4″) convenient to the particular use case. The identity capture function can use all the radio technologies of a mobile operator in case there are several technologies active (e.g. GSM and UMTS).

The central unit 2 has the following functions:
A collection function, carried out by data collection means 5, that collects the captured identities. It will typically be centralized (i.e. as network server) and collect concurrently the data from different local units (1,1′,1″) sent via user plane (typically via an IP network). This collector function could perform the remote management of the local units as well (e.g. triggering alerts when the local units are down, changing their operating parameters, etc.). Besides, it could support a multi-operator scenario, aggregating the captures obtained from local units (1,1′,1″) radiating in the spectrum of different mobile operators of that country or region.
An identity management function, carried out by management means 6, which transforms the IMSI identities (internal to the cellular network) into identities that can be useful to advertisers. The main conversion is from IMSI to MSISDN (i.e. to the telephony identity that could be used afterwards to send messages or make calls)—the mapping of these two types of identities is property of the mobile operator (it is stored in the HLR database). The management means 6 communicates 10 with the corresponding mobile operator (8,8′) to obtain the MSISDN stored in its HLR database. Besides, this identity management function could include also a conversion from IMSI to PLMN, which keeps customer anonymity but can be valuable to advertisers as well (e.g. detection or roamers). It should be noted that the PLMN corresponds to the first 5 digits of the IMSI number in Europe. The first three, called MCC, indicate the country and the last two, called MNC, indicate the mobile operator within that country. The table of PLMN codes is public and well-known.
A gateway function, carried out by interface means 7, to provide the service to advertisers (9,9′,9″). This function would at least include the following sub-functions:
   interface to advertisers (9,9′,9″), based on a certain protocol, typically standard, such as OMA MLP (Triggered Services) or Parlay X Part-9
   privacy control, to ensure that the advertisers (9,9′,9″) only get what they are allowed to, and that the user privacy settings are enforced. Although the identity capture function has the technical capability to capture all users of a certain operator and radio technology (e.g. GSM or UMTS), only those users with explicit consent will take part of identified services, while the rest of identities will be discarded. This consent is obtained through external means out of the scope of the invention (e.g. by the advertiser in its direct commercial relationship with customers) and then is made visible to this function (e.g. by populating a database in this function or allowing the function to query an external database). On the other hand, all users could take part on anonymous services, such as detecting what PLMN they belong to.
   brokerage between the requests by advertisers (9,9′,9″) and the collection of events in the identity captured functions (i.e. mapping ones with the others). This is needed because the request by a single advertiser can be associated to several local units, and in a similar way, the events in a local unit can be associated to several advertisers.

The interface means 7 communicates 20 with the advertisers (9,9′,9″), receiving their requests (e.g., subscribing to the local marketing service) and sending the event of a user being detected by a local unit (1,1′,1″). The advertising systems will act accordingly (e.g. sending an MMS with a coupon), depending of the configuration of the campaign, segmentation, targeting settings, etc. The behaviour of the advertising systems once they have received the trigger is out of the scope of the invention, which covers only the system and method for producing that trigger and associate a valid identity (e.g. MSISDN) that allows the advertising systems the delivery through the regular cellular channel (e.g. SMS, MMS, WAP Push) or enable them to extract valuable commercial information (e.g. PLMN) in anonymous way.

The function for capturing cellular identities (identity capture function) must always include a unit local to the venue (e.g. shopping centre, airport) for radio transmissions and besides may have part of its functionality located remotely in the network. This function replicates a standard cellular mechanism for the dialogue with mobile phones within its reach. In particular, this local unit broadcasts specific system information as if it was a BTS (base station) and forces a Location Update message by all mobile phones within its reach belonging to its cellular network. Then, the function captures the identity of those phones, such as the IMSI, and rejects the Location Update attempts, hence not disturbing the mobile phones further. This behaviour is based on well-known standard cellular procedures for GSM and UMTS and the local unit 1 can be built based on existing picocell or femtocell technology with a very low cost (e.g. below 200 euros). Location Update procedures are described in detail in ETSI 123 909 V4.0.0 (2001-03), a technical report from the European Telecommunications Standards Institute and 3GPP TS 23.012, from the 3rd Generation Partnership Project.

Additional details of this identity capture function are described here:
The identity capture function (composed of the local unit plus optionally some intelligence in network systems) implements a small subset of the functionality of a BTS, BSC/RNC and MSC/SGSN, in particular the one described below.
The local unit 1 transmits and receives in the licensed spectrum of a mobile network operator. This local unit 1 broadcasts system information in the radio interface towards the mobile phones using the standard procedures and channels for that purpose. As part of its Cell Global Identity, this unit broadcasts a LAC (Location Area Code) that is different from any LAC of the real cells of the mobile network in the surroundings (e.g. the operator can book special Location Area Codes for the road usage charging service).
Due to the standard behaviour in any mobile phone, when a phone detects for the first time this Location Area Code because it enters under coverage of the unit, the mobile phone will initiate a Location Update dialogue with the unit.
The identity capture function (local unit and/or network systems) will respond to that dialogue and, again following standard procedures, will force the phone to provide its IMSI number (note that even if the phone answers first with the TIMSI number, which is a temporal identity, the function can still request the phone to provide the IMSI number).
Once obtained the IMSI number, the function will finish the dialogue sending a Location Updating Reject message to the phone with a rejection cause that will make the phone not trying again a Location Update dialogue with the function during a known timer (e.g. 2 hours) or as long as the phone keeps switched on (depending on the chosen rejection cause). This means that the mobile phone will ignore the radio transmissions of the local unit from this moment on and will not try to connect with it even it is still under the coverage of the unit, unless the period expires or the phone is switched off and switched on again within that coverage.
Finally, for every mobile phone captured, the identity capture function will send the IMSI number to the data collection means 5 (which performs the collection function).

The coverage area (4,4′,4″) of the local unit (1,1′,1″) can be typically configured based on two aspects specific to the local unit: first, the transmission power, which determines the reach; second, the features of the antenna system (e.g. radiation pattern, gain, downtilt), which determine the shape of the coverage. In addition, the system information parameters that the regular cells in the mobile network are broadcasting to all mobile phones can be also relevant to determine the coverage of the local unit. All aspects can be statically or dynamically modified to shape a particular area that is convenient to the advertising scenario, e.g. the near space around a shop within a shopping centre.

The operating parameters of the unit (e.g. Location Area Code, transmitting power, antenna system) could be configured locally or remotely via a typical remote Operation & Maintenance system (e.g. based on IP protocols).

As mentioned before, this function for capturing identities could be entirely local (i.e. all the procedure replicating BTS, BSC/RNC and MSC/SGSN can be managed by the local unit, acting standalone) or can be a combination of local unit plus network equipment (some parts or the procedure done locally and others remotely). In any case, a local unit is always required for radio transmissions.

The local unit can be fixed (e.g. installed in the door of a shop) or mobile (e.g. installed in a bus).

The local unit can use all the radio technologies of a mobile operator in case there are several technologies active (e.g. GSM and UMTS).

In case of a multi-operator scenario, some parts of the unit should be duplicated per operator whereas others can be shared (e.g. antenna system).

In terms of physical equipment, in a typical installation there would be local units located at the areas where people has to be detected and one or several network servers performing the functions of collection, identity management and gateway.

1. Method for local marketing at the point of sale, characterized in that it comprises:
broadcasting, in the licensed spectrum of at least one mobile network operator and from at least one local unit, each one located at a local marketing area within a corresponding coverage area, a LAC different from any other LAC of the radio cells of the mobile network in the surroundings;
establishing each local unit a Location Update dialogue with any mobile phone answering to the LAC broadcast, obtaining from each answering mobile phone its IMSI number;
sending each local unit a Location Updating Reject message to each mobile phone whose IMSI number has been obtained;
sending each local unit the IMSI number of each answering mobile phone to a central unit;
obtaining, for each IMSI number, a user identity useful to advertisers;
offering an interface for at least one advertiser to perform requests for capturing user identities in at least one determined local marketing area;
determining, for each user identity received, the at least one advertiser interested in capturing the user identities in the local marketing area corresponding to said user identity received, and providing said user identity to the at least one interested advertiser.

2. Method according to claim 1, wherein the identity useful to advertisers is any of the following:
MSISDN,
PLMN.

3. Method according to claim 1, wherein the coverage area of the at least one local unit is configurable through at least one of the following parameters:
the transmission power to modify the reach;
the radiation pattern of the antenna system to modify the shape of the coverage area.
the system information parameters that the regular cells in the mobile network are broadcasting to all mobile phones.

4. Method according to claim 1, wherein the step of obtaining, for each IMSI number, the identity useful to advertisers comprises retrieving said identity corresponding to said IMSI number from the corresponding mobile operator.

5. Method according to claim 1, characterized in that it comprises checking, before providing the user identity to the at least one interested advertiser, if there is permission to provide the user identity, so that said user identity is only provided to the at least one interested advertiser with the corresponding permission.

6. Method according to claim 1, wherein the broadcasting of the at least one local unit is carried out at the same time in spectrum of different radio technologies of the same mobile network operator.

7. Method according to claim 1, wherein the broadcasting of the at least one local unit is carried out at the same time in spectrum of different mobile operators, the central unit managing the identities captured for the mobile phones of those said mobile operators.

8. System for local marketing at the point of sale, characterized in that it comprises:
at least one local unit provided with cellular radio transceiver means for transmitting and receiving signals in the licensed spectrum of at least one mobile network operator, each local unit being located at a local marketing area within a corresponding coverage area, and being configured for:
broadcasting a LAC different from any other LAC of the radio cells of the mobile network in the surroundings;
establishing a Location Update dialogue with any mobile phone answering to the LAC broadcast, obtaining from each answering mobile phone its IMSI number;
sending a Location Updating Reject message to each mobile phone whose IMSI number has been obtained;
sending said IMSI number to a central unit;
the central unit configured to:
obtain, for each IMSI number, a user identity useful to advertisers;
receive requests from at least one advertiser for capturing user identities in at least one determined local marketing area;
determine, for each user identity received, the at least one advertiser interested in capturing the user identities in the local marketing area corresponding to said user identity received, and provide said user identity to the at least one interested advertiser.

9. System according to claim 8, wherein the identity useful to advertisers is any of the following:
MSISDN,
PLMN.

10. System according to claim 8, wherein the at least one local unit comprises means for configuring at least one of the following parameters that determines its corresponding coverage area:
the transmission power to modify the reach;
the radiation pattern of the antenna system to modify the shape of the coverage area;
the system information parameters that the regular cells in the mobile network are broadcasting to all mobile phones.

11. System according to claim 8, in which the central unit is remote to the at least one local unit, wherein the central unit comprises data collection means configured for remotely managing the at least one local unit.

12. System according to claim 8, wherein the central unit comprises management means configured to, for each IMSI number received, retrieve the identity corresponding to said IMSI number from the corresponding mobile operator.

13. System according to claim 8, characterized in that the central unit is further configured to check, before providing the user identity to the at least one interested advertiser, if there is permission to provide the user identity, so that said user identity is only provided to the at least one interested advertiser with the corresponding permission.

14. System according to claim 8, wherein the at least one local unit is configured to carry out the broadcasting at the same time in spectrum of different mobile operators, being the central unit configured to manage the identities captured for the mobile phones of those said mobile operators.

15. System according to claim 8, wherein the at least one local unit is configured to carry out the broadcasting at the same time in spectrum of different radio technologies of the same mobile network operator.
